(19) United States
(12) Patent Application Publication
(10) Pub. No.: US 2010/0296801 A1
(43) Pub. Date: Nov. 25, 2010

(54) PORTABLE STUDIO

(76) Inventor: Laurie Lane, Missoula, MT (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/766,749

(22) Filed: Apr. 23, 2010

Related U.S. Application Data
(60) Provisional application No. 61/172,113, filed on Apr. 23, 2009.

(51) Int. Cl. G03B 15/00

(52) U.S. Cl. 396/2

(57) ABSTRACT

The present disclosure is directed to portable studio comprising a module with an interior and an exterior. The module includes a floor comprised of at least one panel; side walls detachably connectable to the floor, wherein the side walls are comprised of at least one panel; and a top detachably connectable to the side walls, wherein the top is comprised of at least one panel. The module includes side walls and a top that are comprised of a semi-translucent material that allows ambient light into the interior of the module. The module is configured to create studio-quality photos, videos, and sound recordings.

### CROSS-REFERENCE TO RELATED APPLICATION

The present utility patent application claims priority to U.S. Provisional Patent Application Ser. No. 61/172,113, filed Apr. 23, 2009, the subject matter of which is incorporated herein by reference in its entirety.

### FIELD OF THE INVENTION

The present disclosure relates to photography and other media, and particularly to an apparatus, systems and methods used for photography and other media.

### BACKGROUND OF THE INVENTION

People have used professional photography to commemorate family events, significant milestones, holidays, and the like for nearly as long as the camera has existed. However, access to high quality photography using studio lighting and/or high-grade film or digital output and/or posing techniques with a variety of background choices has traditionally only been available at studios specifically designed for such use.

Many instances may exist where commemorative pictures are desired, but where professional photography has not been available. For example, commonly at malls, arcades, and other public places, user-operated vending machines or kiosks may be provided that incorporate cameras adapted to take pictures. “Photo-booths” such as these, however, typically lack one or all of the following: sophisticated high quality equipment; the availability of differently styled backgrounds; an interactive professional guide to accompany the user through the process of creating professional-quality photographs; connectivity to a sophisticated image database management system; among other things.

There is a need in the art for apparatuses, systems, and methods for providing professional quality photography that is provided in a self-contained, portable unit.

### BRIEF DESCRIPTION OF THE FIGURES

FIG. 1 is a perspective view of a portable portrait studio showing the interior features as though the exterior were see-through, in accordance with one embodiment of the present disclosure.

FIG. 2 is a perspective view of the exterior of a portable portrait studio, in accordance with one embodiment of the present disclosure.

FIG. 3 is a perspective view of one end of the interior of a PS having posing features, in accordance with one embodiment of the present disclosure.

FIG. 4 is a perspective view of another end of the interior of a PS having payment and photography features, in accordance with one embodiment of the present disclosure.

FIG. 5 is a flow diagram describing a process for using the PS, in accordance with one embodiment of the present disclosure.

FIG. 6 is a flow diagram describing a method performed by the PS, in accordance with one embodiment of the present disclosure.

FIG. 7 is a perspective top view of the PS, according to one embodiment of the present disclosure.

FIG. 8 is a perspective view of one embodiment for attaching the side wall panels to the floor.

FIG. 9 is an interior view of one end of the PS showing the posing features, according to one embodiment of the present disclosure.

FIG. 10 is an interior view of the end of the PS housing showing the on-screen display, according to one embodiment of the present disclosure.

### BRIEF SUMMARY OF THE INVENTION

The present disclosure, in one embodiment, includes a portable studio that includes a module with an interior and an exterior. The module has a floor comprised of at least one panel; side walls detachably connectable to the floor, where the side walls are comprised of at least one panel; and a top detachably connectable to the side walls, where the top is comprised of at least one panel. The side walls and the top of the portable studio are comprised of a semi-translucent material that allows ambient light into the interior of the module. The module is further configured to create studio quality photos, videos, and sound recordings.

The present disclosure in another embodiment includes a portable studio that includes a module that has a generally curved exterior, a semi-translucent top, and an inside of sufficient size to allow entry to the inside by at least one person. The module also includes high-quality photography equipment, an on-screen display, a printer operably connected to the high-quality photography equipment; a payment mechanism located on the module; and a server that operably connects the photography equipment, the on-screen display, the printer and the payment mechanism. The module also includes software that displays an interactive guide on the on-screen display that guides the at least one person in the use of the apparatus.

The present disclosure in yet another embodiment includes a method for providing an interactive photo session that includes the following: providing a module having a generally curved exterior, a semi-translucent top, and an inside of sufficient size to allow entry to the inside by at least one person in order for a photo session to be initiated and completed. The module includes high-quality photography equipment; an on-screen display; a printer; payment mechanism; a server operably connecting the photography equipment, the on-screen display, the printer and the payment mechanism; and software that displays an interactive guide on the on-screen display that guides the at least one person in the use of the apparatus. The method further includes directing the at least one person once they have entered the module to select photo options for their photo session. The method further includes requesting payment from the at least one person via the payment means. Next, the method includes capturing at least one photograph, video imagine, or sound recording of the at least one person; providing the at least one person the option of altering the photograph, video image or sound recording; confirming a final product the at least one person will purchase; and making the final product available to the at least one person.

While multiple embodiments are disclosed, still other embodiments of the present disclosure will become apparent to those skilled in the art from the following detailed description, which show and describe illustrative embodiments of the disclosure. As will be realized, the various embodiments of the disclosure are capable of modifications in various obvious aspects, all without departing from the spirit and scope of the present disclosure. Accordingly, the drawings and detailed description are to be regarded as illustrative in nature and not restrictive.

### DETAILED DESCRIPTION

The present disclosure relates to novel and advantageous apparatuses, systems, and methods for providing professional studio photography. More particularly, the present disclosure relates to a professional photography experience that may be provided in a self-contained module or unit that may be portable.

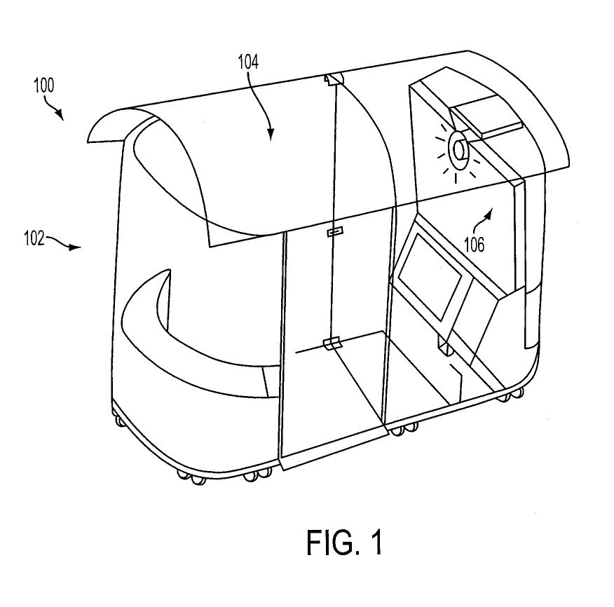

Generally speaking, as shown in FIG. 1, the portable studio (hereinafter “PS”) 100 of the present disclosure may comprise, in some embodiments, an external assembly 102, an internal assembly 104, and an interactive photography system 106.

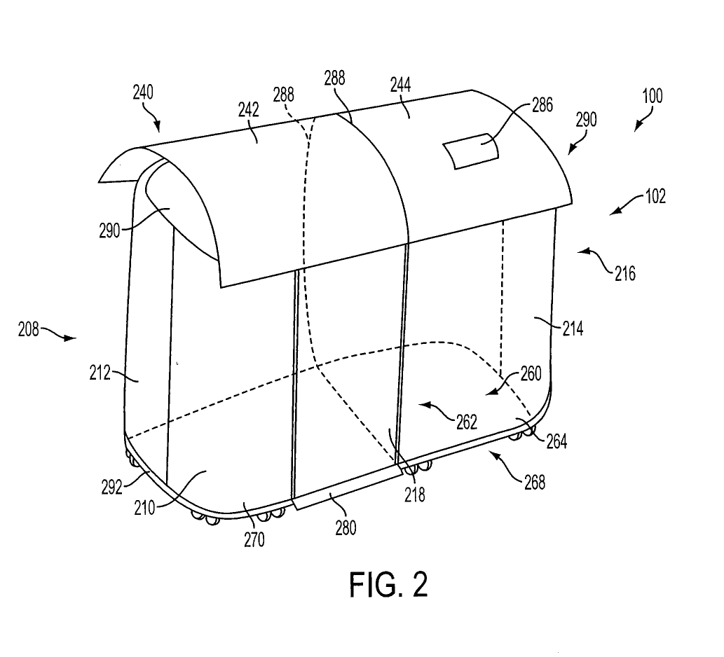

In some embodiments, as shown in FIG. 2, the external assembly 102 may include side walls 208, a top 240, and a floor 260.

As may be seen in FIG. 2, in one embodiment, when the PS 100 is in an erected state, the side walls 208 may be curved, for example, so as to generally create a circular or oval cylinder. In other embodiments, the side walls may be configured to create any other suitable or advantageous shape, for example a rectangular box or any other polygonal shape. In still another embodiment, the walls may be configured to form an irregular shape, for instance, one end of the PS may bulge out or provide more interior space than the opposite end of the PS.

The side walls may be comprised of one continuous wall in some embodiments, while in other embodiments the side walls may be comprised of two or more panels. As shown in FIG. 2, the side walls 208 may be comprised of four panels 210, 212, 214, and 216, for example. While a PS comprising four side wall panels is shown and described, it will be recognized that the side walls may be configured from two panels, three panels, five panels, eight panels, or any other suitable number of panels.

An entranceway or door 218 may also be provided as part of the side walls 208. In one embodiment, the door 218 may be integral with one or more of the side panels, while in other embodiments the door 218 may comprise its own panel. The door may be of any known type, such as a swinging door, a hinged door, or any other type of door. In some embodiments, the door may be a pocket door configured to laterally slide into one of the adjacent wall panels. The entryway created by the door may be of any suitable width. In some embodiments, the entryway may be at least wide enough to permit a person in a wheelchair to comfortably access the interior of the PS. It will be recognized, however, that the entryway may be any suitable width to allow one or more people to enter the interior of the PS.

The side walls 208 may be comprised of a generally lightweight yet sturdy material, such as plastic, wood, metal, or any other suitable material, or combination of materials. In some embodiments, the side walls 208 may be made of a semi-translucent material, for example, a molded resin, polypropylene, or any other material or combination of materials. In such embodiments, the side walls (as well as the floor panels and top panels) may be generally white, off-white, cream, beige, gold, or silver for example. In still other embodiments, the side walls 208 may be any color. In some cases, the exterior side of the side walls may be one color and the interior of the side walls may be another color. In still other embodiments of the present disclosure, the side walls may include designs, patterns, writings, images, messages, advertisements, or mirrors for instance.

The panels of the side walls 208 may be approximately ⅛ inch to approximately 2 or more inches thick, in some embodiments. More preferably, the side walls may be approximately ¾ inch to approximately 1 inch thick. It will be recognized, however, that the side wall panels may have any suitable degree of thickness.

The side wall 208 panels may generally be of a suitable height to permit most people to enter and stand comfortably inside the PS. Specifically, in some embodiments, the side walls may be from approximately 65 inches to approximately 110 inches tall. In still other embodiments, the side walls 208 may be from approximately 70 inches to approximately 80 inches tall. In still other embodiments, the side walls 208 may be approximately 72 inches tall. In some embodiments, each side wall 208 panel and/or the door 218 may have a uniform thickness and/or height and/or may be comprised of the same material. In other embodiments, each panel or some panels may have a different thickness and/or height and/or may be comprised of a different material relative to another panel or panels, as desirable. In still other embodiments, there may be variation within a single side wall panel as to the thickness and/or height of the panel. Similarly, a single side wall panel may be comprised of a single uniform material or may be comprised of multiple materials.

The side wall door 218 may be made of a different material than the side wall 208 panels in some embodiments of the present disclosure. For instance, the door 218 may be comprised of a thinner material than the other side wall panels. For example, the door 218 may be comprised of a thinner rigid resin, or any other suitable material or combination of materials. The door 218 may be from approximately ⅛ inch thick to approximately 1 inch thick in some embodiments. More preferably, the door may be from approximately ⅙ inch thick to approximately ¾ inch thick. Still more preferably, the door may be approximately ¼ inch thick.

The floor 260 of the PS 100 may have a walking surface 262 and an under surface 268. The walking surface 262 may be the side of the floor 260 that may be face-up in the interior of the PS, whereas the under surface 268 may be the side of the floor oriented toward the ground when the PS is in an erected state. As shown in FIG. 2, the floor 260 may be comprised of two detachably connected floor sections 264, 270. In other embodiments, the floor 260 may be comprised of a single section or any number of separate floor sections that have been detachably connected, for example three, four, five or more separate pieces may be detachably secured to form a generally continuous floor surface. In embodiments where the floor 260 is comprised of 2 or more floor sections, the floor sections may be configured to be connectable and secured to one another by any suitable means, or combination of means. For example each floor section may connect to an adjacent floor section by means of tongue and groove, puzzle-piece edging, hinges, or any other locking and/or securing mechanism or combination of mechanisms.

The floor 260 may be comprised of any suitable material, or combination of materials. For example, the floor may be comprised of a relatively thick rigid resin, or the floor may be comprised of any other suitable material, or combination of materials, such as but not limited to any other plastic, metal or wood, for example.

In some embodiments, the shape of the floor 260 surface may have substantially the same or similar shape to the shape created by the bottom edges of the side walls 208 when the PS 100 is erected. In such embodiments, the floor 260 surface may be a little larger than the surface area created by the walls 208 in an erected state. In still other embodiments, the floor 260 surface may be substantially the same size as the surface area created by the bottom edges of the side walls 208 when the PS is in an erected state.

The under surface 268 of the floor may have a portability device or apparatus detachably or fixedly secured to it. In one embodiment, as shown in FIG. 2 for example, several sets of wheels 296 may be attached to the under surface 268 so that the PS 100 may be relatively easily moved and positioned by, in some cases, a single user. Any suitable number of wheels or sets of wheels may be provided, including two wheels, or any other number of wheels greater than two. In another embodiment, coasters, sliders, or other portability device may be affixed to the under surface 268 in any suitable number or position.

In some embodiments, there may be a mechanism provided for hiding or removing, for instance, the portability device. For example, there may be grooves provided underneath the floor boards such that the wheels, coasters, or other portability mechanism may be secured within the floorboards when the PS has been positioned in an ideal and/or relatively permanent location, for example. The portability device may be moved from an extended position to a secured or hidden position and back again by any known mechanical or electrical means, such as by a lever or levers, gears, or any other suitable means.

In some embodiments, a braking mechanism such as wheel brakes, for example, may be provided on the under surface 268 of the floor 260. Brakes may allow the PS to be safely and securely positioned once the PS is in a desired location. The braking mechanism may be any known mechanism for stabilizing and securing a portability apparatus and/or securing the PS to the ground, for example. In some embodiments, the portability apparatus, or wheels for example, may be retracted such that the PS may be lowered to sit on the ground. When the PS is ready for moving to another location, the portability apparatus may be detracted, lifting the PS from the ground and allowing the PS to be moved relatively easily using the portability apparatus.

As shown in FIG. 2, in some embodiments a ramp or seal 280 may also be provided at the bottom of the entranceway 218 to bridge any distance between the ground and the interior floor of the PS 100. The ramp 280 may extend out from a pocket in the floor section, in some embodiments, such that the ramp 280 may be positioned in a hidden first position for storage and transportation and an extended second in-use position when the PS is in an erected state. In other embodiments, the ramp 280 may be integral with the floor section and may not move or have a stored or hidden position. It will be recognized that any means of providing a ramp 280 that may slope downward at an angle from the height of the floor of the PS to the ground is within the spirit and scope of the invention, such as, for example providing hinges to connect the ramp 280 to the floor section.

The top 240 of the PS in some embodiments may be a single piece of material or the top 240 may be comprised of two or more sections of material. In one embodiment, as shown in FIG. 2, the top 240 may be comprised of two pieces 242, 244 that may generally fit together to form a single piece. While two sections or pieces are shown in this embodiment, it will be recognized that the top may be comprised of any number of sections. The top 240 may be comprised of any suitable material, such as, but not limited to plastic, metal, or wood. In one embodiment, the top 240 may be comprised of a lightweight flexible semi-translucent resin. The top piece or pieces may be generally flat or may be curved to any suitable degree. As may be seen, in some embodiments, the roof may generally take the shape of an arch, a generally semi-cylinder, or an upside down bowl when the PS 100 is in an erected state. This shape may be obtained by bending flexible flat panels, for instance, or in other embodiments the top section or sections themselves may already be statically curved. It will be recognized, however, that the top of the PS may take any other suitable shape, including a non-uniform shape, such as a wave-like shape, for example.

Further, the top 240 may also comprise a solar panel 286 or panels such that the PS 100 may take advantage of solar energy for some or all of its energy needs. The solar panel or panels may be positioned in any suitable place and/or pattern on the top 240 of the PS. In some embodiments, a solar panel 286 or panels may be alternatively or additionally positioned on the side walls 208 of the PS.

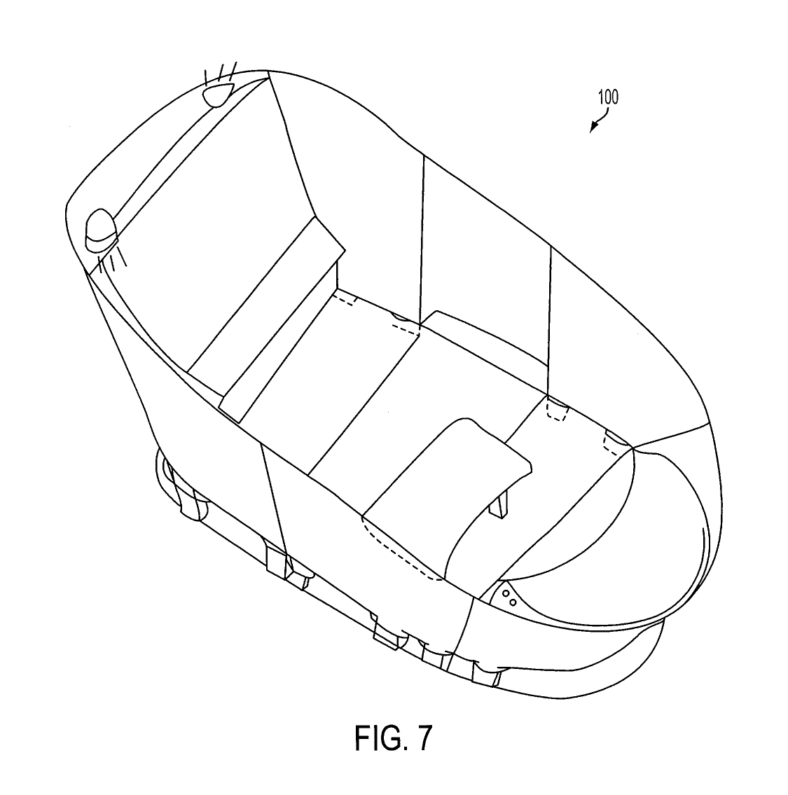

FIG. 7 shows a top view of the PS looking down into the PS, according to one embodiment of the present invention.

As discussed earlier, one advantage of the PS of the present disclosure in some embodiments may be that the PS may be relatively lightweight and relatively easy to assemble from an unassembled state. In some cases, the PS may be transported, assembled, and disassembled by one person. Following is a general description of how the PS may be assembled from an unassembled state according to some embodiments of the present disclosure.

In embodiments where the floor 260 has two or more sections, the floor sections may be fit and locked together. The side wall 208 panels, in some embodiments, may then attach to the floor 260 via grooves, cut-outs, including puzzle-piece edging, for example, in the floor. This may also make set-up and break-down of the module relatively easy. In such an embodiment, the floor surface may be generally uniformly wider than the surface created by the side walls 208 in an erected state. The ends of the side wall 208 panel or panels that connect to the floor 260 may be configured to slide into a groove in the floor. In other embodiments, any other suitable method for detachably securing the side wall 208 panel or panels to the floor may be used, such as latches, braces, pins and hooks, or any other suitable mechanism or combination of mechanisms.

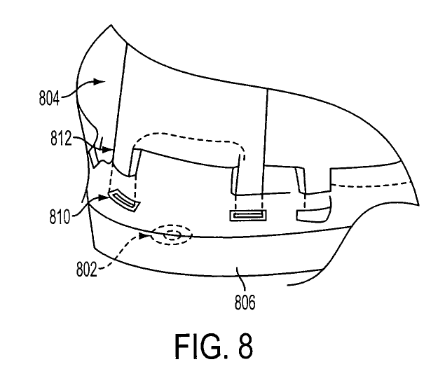

In one embodiment, shown in FIG. 8, the side wall panel or panels 804 may be secured to the floor 806 by a plurality of teeth 812 provided on the bottom edge of the side walls 804 that may fit into a plurality of slots 810 provided in the surface of the floor 806. In some embodiments, a hinge 806, for example, may further secure the side wall panel or panels 804 to the floor 806.

In some embodiments comprising more than one side wall 208 panel, adjacent side wall panels may be detachably fastened to one another by any suitable mechanism to provide additional stability to the assembled PS. For instance, latches, braces, hooks and pins, puzzle-piece edging, tongue and groove connection, or any other suitable mechanism or combination of mechanisms may be used to fasten adjacent sidewall panels to one another. In some embodiments, the panels may help support and hold the PS module securely in place. The panels may, in some embodiments, snap or lock or rest together via, for example, cut-outs, knobs, teeth, or tongue and groove molded materials such as, for example, resin, plastic, metal, Plexiglas, wood, or another substrate or combination thereof. This may also be true of the floor panels and top panels.

To provide further stability, in one embodiment, shown in FIG. 2, the floor 260 may comprise a base ring 292 that may extend around the entire perimeter of the floor 260, except for the bottom portion of the entrance way 218. The base ring 292 may be comprised of any suitable material, such as metal, plastic, wood, or any other suitable material, or combination of materials. The base ring 292 may extend vertically upward from the floor a certain distance, which may be any suitable distance from approximately ½ inch to 3 or more inches. The base ring 292 may help secure the side wall 208 panels when the PS is in an erected state.

The top 240 panel or panels of the PS may be positioned on the top edges of the side wall 208 panels. The side wall 208 panel or panels may have grooves in the top edges to allow corresponding grooves in the top panels to slide together thereby securely fitting together the side wall 208 panels and the top 240 section or sections. In other embodiments, any other suitable method for detachably securing the top panel 240 or panels to the side wall 208 panels may be used, such as latches, braces, pins and hooks, or any other suitable mechanism or combination of mechanisms. As mentioned earlier, in some embodiments the top 240 panel or panels may be flat panels that are flexible and may be bent to form a curved top to the PS as may be seen in FIG. 2.

As may also be seen in FIG. 2, in some embodiments a division area 288 may be provided in an assembled PS. The division area 288 may be created by the top 240 sections, side wall 208 panels, and floor 260 panels joining together in an erected state such that there may be a vertical alignment of the seams of the panels comprising the top 240, the side walls 208, and the floor 260. The division area 288 may allow the PS to be expanded or separated at the division area 288 to allow more room in the PS. Accordingly, by dividing the erected PS in such a manner, the PS may comfortably hold a greater number of people than when the PS is in a non-expanded state allowing for groups of people and/or families and/or sports teams and the like to be photographed comfortably. Separation and extension of the module 100 may generally be accomplished by the user through physical force using guides and levers, or it may be accomplished automatically by a motor, hydraulics, or other suitable automatic force, for example.

The overall size of the PS when the PS is in an assembled state may have any suitable dimensions. In preferred embodiments, the overall size may be such as to allow from one to four people of at least average size to be comfortably situated inside of the PS for a photo session. In some embodiments, the PS in an erected state may be generally the size of an SUV or smaller. As described earlier, the size of the PS in some embodiments may be increased by separating the PS into at least two parts at the division area 288. The size and shape of the PS may also be configured so as to permit placement of the module in specific locations, for example, in shopping malls, or in other businesses or business areas.

Turning now to the internal assembly of the PS, the internal assembly, in some embodiments, may comprise structural lighting features, posing features, payment features, photography features, security features, and power features.

The advantageous structural lighting features of the PS may derive from several sources. As described previously, in some embodiments, the side wall 208 panels and top 240 of the PS may be comprised of a semi-translucent molded resin or polypropylene that may be substantially light in color, for instance white, cream, light yellow, gold, silver, etc. In such embodiments, ambient light may easily pass through the top 240 and sides 208 of the PS and into the interior of the PS, the tops 240 and sides 208 thereby acting as a large soft reflector that may create a soft, natural, complimentary lighting for photography in the interior of the PS. In some embodiments, the side wall 208 panels and/or top 240 may be configured to, or made of a material designed to, diffuse the ambient light.

Additionally, as may be seen in FIG. 2, in some embodiments the top 240 and the side walls 208 may be designed such that they do not meet at all points, but instead may be configured to provide an open area 290 on one or more sides or ends of the PS. Ambient light may pass directly through these open areas 290 into the interior of the PS, thereby creating additional natural lighting for photography. These open areas 290 may also provide for additional head space in the module, and for better air circulation within the PS. The open areas 290 may also aid in the assembly of the PS.

In some embodiments, the lighting inside of the PS may also be enhanced by providing a painting or coating on the walking surface 262 of the floor 260. The painting or coating may have a reflective substrate in it that may throw light back up toward the subject, in some embodiments. Such a painting or coating may have the added benefit of making the floor easier to clean and keep clean.

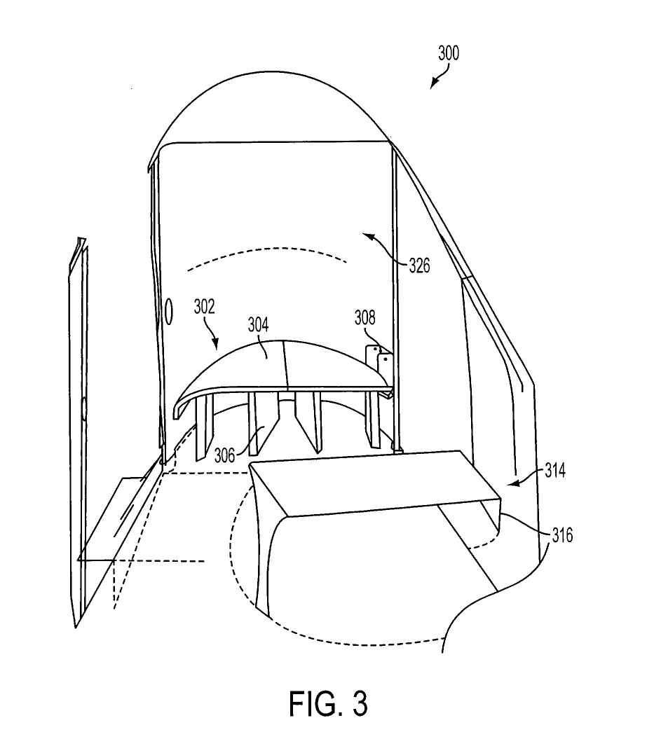

As may be seen in FIG. 3, the posing features 300 of the interior assembly of the PS may include a bench 302 or other suitable seating unit, a posing table 314, and a background 326 in some embodiments.

The bench 302 may be positioned at one end of the interior of the PS. The shape of the bench 302 may substantially conform to the shape of the side wall panel or panels abutting the bench. In other embodiments, however, the bench 302 may take a different shape than the shape of the side walls adjacent the bench 302. The seating unit or bench 302 may be molded to fit the curvature of the module and may rest upon the molded shape of the side walls 208. The bench 302 may be solid or it may be hollow. For example, in one embodiment the seating surface 304 of the bench may be integrally connected to the base 306 of the bench 302, as may be seen in FIG. 3. In another embodiment, however, the seating surface 304 may lift up to expose a compartment contained in the base of the bench. The compartment may be used to store items that may be useful for photography such as toys, mirrors, stuffed animals, tissues, cushion(s) for the bench, other decorative items for the bench, or any other item or items, or combination of items that may be useful. In still another embodiment, the seating surface 304 of the bench 302 may be supported by a base 306 comprising two or more legs, posts, or panels, for example. In some embodiments the legs, posts, or panels 306 may be hollow. In some embodiments the leg or legs may have hinges that allow the legs to be folded up or out from underneath, or next to seating surface 304 for storage or transport. The bench 302 may be of any suitable height and/or width. In some embodiments, the bench 302 may be easily removed or hidden away to allow for portraits to be taken from a standing or kneeling position, for example. The bench 302 may also have a connectivity panel or area 308. The connectivity area 308 may have outlets, buttons, wires, cables, ports or other way to communicate with the photography system (described further below).

The posing features 300 of the interior assembly of the PS may also include a posing table 314. The posing table 314 may be comprised of any suitable material or combination of materials, for example, plastic, metal, or wood. In some embodiments the posing table 314 may be white and have a reflective surface or coating that may help throw light on the subject, to enhance the lighting of the photos. It will be recognized, however, that the posing table 314 may be any color. In some embodiments, the posing table 314 may be positioned an appropriate distance in front of the bench 302, for example, but not limited to approximately one foot in front of the bench 302, so that a user may sit on the bench 302 while placing their hands and/or forearms, for example, on the posing table 314. Some embodiments may include a posing table 314 suitable to allow a user to pose in various positions such that a variety of photographs may be produced. A user may also choose to put certain items on the posing table 314, such as trophies, other awards, or objects of importance to them on the table so that the objects may be included in a photograph. Alternately, the posing table 314 may be used exclusively to display objects, for example, products. In some cases, a user may wish to obtain high-quality photographs of an item they wish to sell, possibly on the internet. The posing table 314 may be used for this purpose.

One end of the posing table 314 may be fixedly connected 316 to the interior of one of the side walls, for example. The other end, or free end, of the posing table 314 may be detachably secured to the same side wall by a latch or other mechanism, for example. The posing table 314 may be extended for use in such an embodiment by unlocking the free end from the side wall and allowing the posing table 314 to fall open perpendicularly to the floor. In another embodiment, the posing table may be detachably or fixedly connected to the side wall at one end of the posing table and may be supported at the other end of the posing table by one or more legs or posts when the posing table is in an extended position. In still another embodiment, the posing table 314 may not be connected to a side wall, but rather may be entirely free-standing and capable of being moved into or out of the PS as desired. While these embodiments are described with some detail, it will be recognized that any known method for supplying a posing table may be used. The posing table may be of any suitable width and/or height, and in some embodiments the posing table may have an adjustable height and/or width.

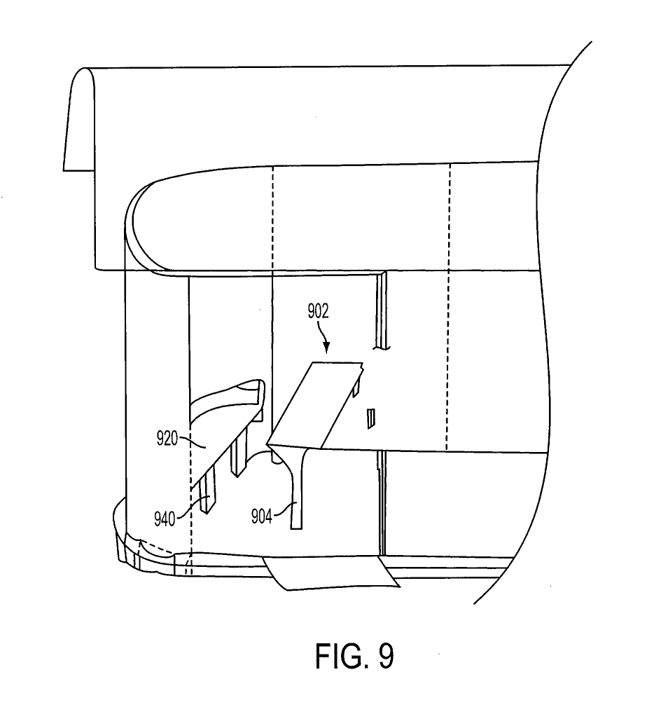

As may be seen in FIG. 9, in some embodiments the bench 920 may be supported by a plurality of legs 940. The posing table 902, in some embodiments, may also be supported by one or more legs 904.

In some embodiments the posing features 326 may include a physical background located within the module, while in other embodiments the background may be a digitally created background added by computer software to the photograph digitally. In embodiments providing a physical background 326, the interior side wall panel or panels located behind the bench or posing area may include a white or green screen behind the user and may use white/green screen technology, such that when a photograph is taken, computer software may superimpose a background in place of the white or green, in some embodiments.

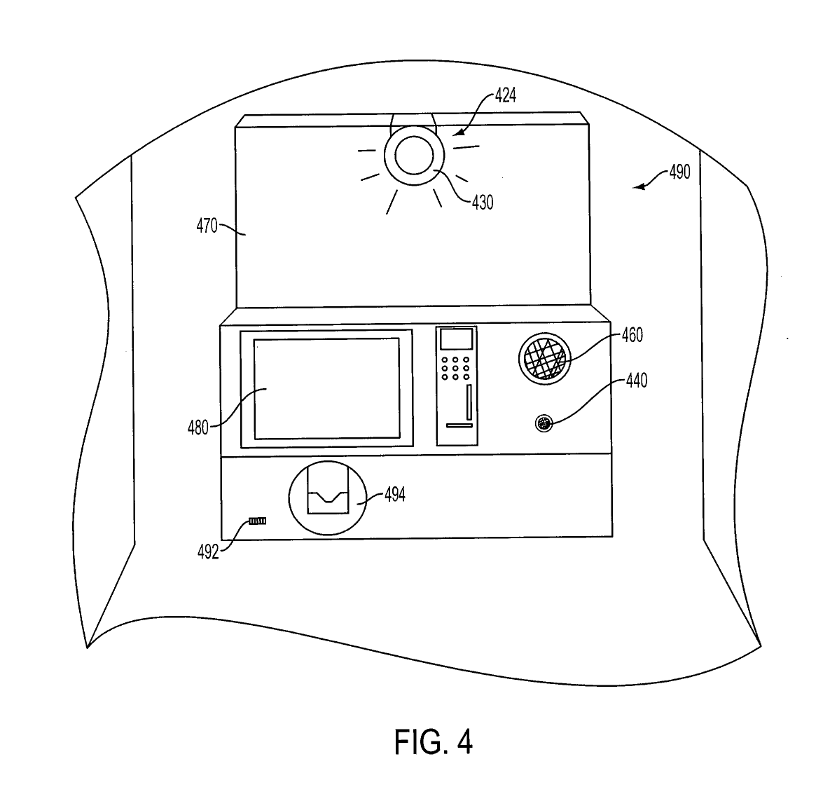

As may be seen in FIG. 4, the payment features 410 of the interior assembly of the PS may include credit card and/or dollar (and/or coin) receiver, a receipt printer, and/or a change receiver. The payment features 410 may be located in any suitable place on the interior or exterior of the PS. In alternate embodiments, the payment features 410 may be located remotely from the module. In some embodiments, as shown in FIG. 3, the payment features 410 may be located at the end of the PS opposite the bench. Each of the payment features 410 are well known in the art. Payment may be required before, during, or after the module is operated by a user.

The photography features of the interior assembly may include in some embodiments: photography equipment; a monitor and on-screen display; an interactive screen; and printer elements.

The photography equipment may include a camera 424, a camera lens 430, an apparatus for recording sound, and lighting elements capable of creating high-quality digital photography, in some embodiments. The photography equipment may be capable of producing photographs, including 2D and 3D photographs and/or videos, including high-definition (HD) videos, in some embodiments.

The PS may include one or more camera 424 and/or lens 430. The one or more camera 424 and lens 430 may be of any suitable type to create professional-quality photos. In one embodiment, the camera 424 may be a digital camera. For example, a quality 28-105 zoom portrait lens with an aperture of f2, for example, at its widest and f16, for example, at its smallest may be provided. It will be recognized, however, that any suitable camera and/or lens may be used in embodiments of the present disclosure. The quality camera lens 430 may create complimentary portraits, in some embodiments, by bringing the subject's face forward while softening the background with shallow focus when the camera 424 is used in portrait mode. This may create a richer image and therefore better quality overall in some embodiments. The automatic lens in some embodiments may focus and zoom according to which mode it is used in, thereby creating a lesser depth of field and softer focus, for example, at aperture f2 for portrait to f16 for a sharper depth of field range that may accommodate larger groups. The lens may be located at any suitable place. In some embodiments the lens 430 may be located a few inches above a sitting person's eye level, for instance, to help alleviate “double chins” and closed eyes.

In one embodiment the camera 424 and/or camera lens 430 may be configured to take 3D photos or images. In still other embodiments, 3D images may be provided by software that may, for example, off-set two or more images. In still other embodiments, other techniques or combination of techniques may be used to produce 3D images.

An apparatus and/or system for recording sound 440 may also be provided with the photography equipment, such that the user may create a greeting card or other combination using both visual and audio capabilities. Suitable sound recording device may be commercially available and known. Device for recording sound may include in some embodiments a surround sound recording microphone for example. Sound may be provided by digitally stored audio files, such as music or sounds. The photography equipment, in some embodiments may also include a CD and/or DVD burner that may be used to provide a user with a CD or DVD containing video, images, and/or sound resulting from the photo session. One or more speakers 460 may be provided within the PS so that the user may hear the on-screen guide and/or hear playback of sounds recorded by the user. The speakers may be any suitable type of speakers. In some embodiments, the speakers may be 5.1 or 7.1 speakers for surround sound, for example. A user may be able to adjust the sound level in some embodiments according to known technology. In some embodiments, a scanner may also be provided in the PS.

The photography equipment may also include lighting elements. In some embodiments, a high-quality lighting system, specially adapted for use within the PS may be provided. The lighting system may include lights of various intensities and colors, located at various locations within the module to create a photo-studio appearance when a photograph is taken. In some embodiments, one or more studio quality strobe lights may be provided. For example, a strobe light in the form of a ring light may surround the entire interactive screen 480 and/or the on-screen display 470. Alternately, or additionally, a ring light—round or square, for example—may be provided around the lens of the camera 424 and/or a flash unit may be placed near the subject that may allow the flash when triggered to reflect from the curved ceiling, floor and/or walls, in some embodiments creating a soft overall light quality. In addition, monolights, parabolic, and/or soft box lights, reflected or direct, bare bulb lights, LED lights, tungsten, bounced or diffused through filters and screens may be provided in the PS. There may also be provided additional side panel lights of any suitable dimension that may allow for additional creative lighting techniques such as those used by professional photographers in a studio setting, for example. The flash units, in some embodiments, may be triggered wirelessly and remotely upon shutter release of the camera lens, for instance, via bluetooth or infrared technology. In some embodiments, the user may control the lighting via the on-screen display 470.

As discussed previously, lighting may also be provided by the semi-translucent module top and side walls which may, in conjunction with the above-described lighting features create reflective light and overall soft even light with soft shadows and beautiful catch lights. In some embodiments, the semi-translucent module top can be configured to assist in high quality photography, such as by providing certain lighting characteristics or shading/shadowing characteristics, etc. In some embodiments, the interior walls may be curved to assist in improving the overall light quality on the user. In further embodiments, one or more of the walls, ceiling, floor and posing table of module may be made to incorporate a reflective lighting material or have a reflective lighting quality to aid in the overall light quality on the user. The reflective lighting quality of the interior of the module may be provided in combination with the high-quality lighting system to provide complimentary lighting to the user or users, and provide high-quality photographs using the photography equipment.

The photography features may also include a monitor and on-screen display 470. In some preferred embodiments, the on-screen display 470 may be used to display an interactive guide that may help guide the user through the photography session. The interactive guide may be provided by accompanying software that will be described in greater detail below with respect to various disclosed embodiments. The model or spokesperson may be a particularly advantageous feature of many embodiments. In some embodiments, it may generally replicate or imitate what a user would experience in a traditional professional photo studio.

Further, the on-screen display 470 may be used to show a real-time image of the user as the user poses during their photograph session, thereby allowing the user, in some embodiments, to capture the ideal and/or desired shot in real-time. Still further, the on-screen display 470 may be used to display photographs that have been taken, allowing a user to see and/or select the photographs they may wish to alter and/or enhance and/or purchase. In still other embodiments the on-screen display 470 may be used to communicate with a user in any other way for any other suitable purpose. Such functionality may also be provided by accompanying software described in further detail below.

The on-screen display 470 may be housed in a console 490 that may or may not incorporate other elements of the interior of the PS. For example, the computer program, processor, CD-DVD burner, digital speakers 460, stereo microphone 440 and lighting may or may not be seamlessly incorporated within the on-screen display 470 itself and/or the on-screen display housing 490. Additionally, in some embodiments the on-screen display 470 and/or the housing 490 for the on-screen display may include or also include, the interactive screen 480, the printing elements, and/or the photography equipment. The on-screen display 470 may be positioned in a location accessible to the user or users of the module, for example, the on-screen display 470 may be positioned at an end of the PS opposite the posing table 314 and bench 302. The display 470 may have any suitable dimensions. In some embodiments, the on-screen display 470 screen may be approximately 34 inches or larger. It will be recognized, however, that the screen may be smaller than 34 inches. In some embodiments, the on-screen display 470 may be a flat panel monitor, such as an LCD monitor, although other suitable display devices may be used. The display 470, in some embodiments, may have touch screen capabilities, such that the user may be able to select from various choices or options that may be displayed. As discussed above, the on-screen display 470 may also have photographic light and/or lights and/or strobes, for example, surrounding the screen. Similarly, one or more speakers may be incorporated into the on-screen display unit.

The photography features may also include an interactive screen 480 in some embodiments. The interactive screen 480 may have touch screen capabilities. In some embodiments, the touch screen may be used to make selections shown on the on-screen display 470. In other instances, the interactive screen 480 may be used to make selections shown on the interactive screen 480 itself. In some embodiments, the user may make selections by pushing buttons, for example, located on or near the interactive screen. In some embodiments, the on-screen display and the interactive screen may be a single combined unit. The interactive screen 480 may be positioned at any suitable location within the PS, for instance as shown in FIG. 4, the interactive screen may be located below the on-screen display at a height that may be easily accessible for most people.

The printer elements may include a paper tray, printer, and/or printer tray 494. These elements may be located at any suitable place in the interior or exterior of the PS. In some embodiments, some or all of the printer elements may be housed partially or entirely within other components, such as the on-screen display housing 490, for example. These elements are well known and commercially available for incorporation into the PS. In some embodiments, some or all of the printer elements may be located remotely from the PS, such as for example, a near-by help or service desk. In some embodiments the printer may be a dye sub printer that may be located, for instance, under the on-screen display and/or interactive screen.

The PS may also have a input/output for a cell phone 492 to connect to the PS in order for the user to download images to be printed, in some embodiments, and/or to be able to download images that may be purchased.

The PS may also have certain security features provided as part of the interior features, in some embodiments. In some embodiments, for instance, the PS may be placed in a mall or other location where the PS may be operated by a user substantially free from oversight. Accordingly, the potential for vandalism may be present. Additionally, there may be some risk that inappropriate subject matter may be photographed and uploaded to the Internet, for example. Consequently, the PS may include in some embodiments one or more security cameras or other security devices on the inside and/or outside of the module. In some embodiments, the security camera or cameras may be small and unobtrusive, but the camera or other security features may be of any appropriate size and may be placed in any suitable area of the PS.

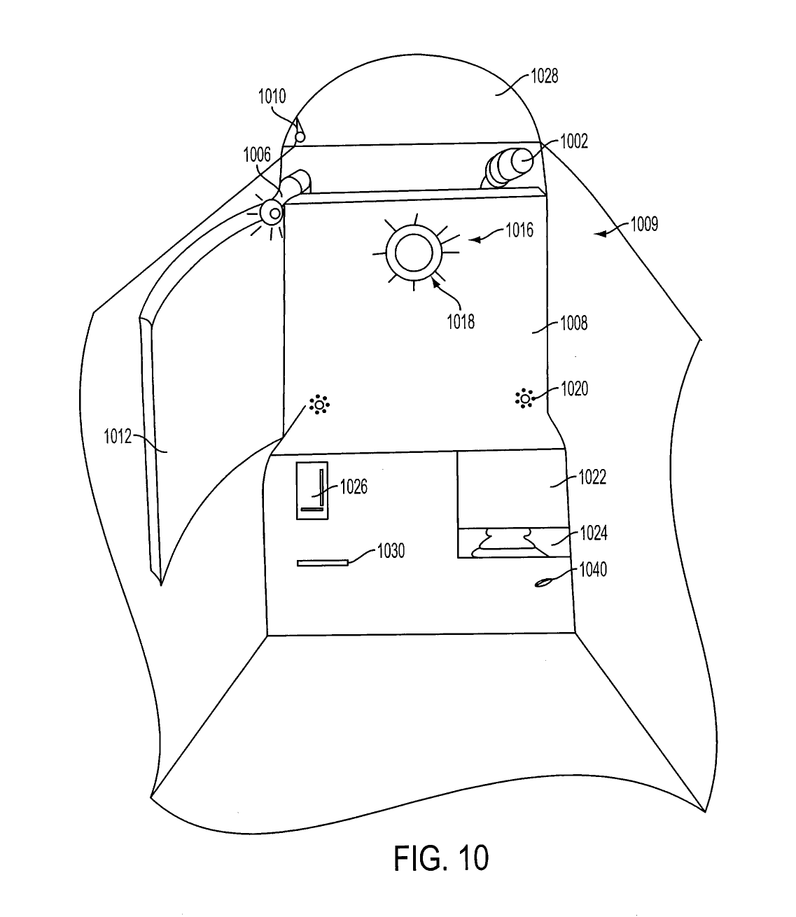

FIG. 10 shows another embodiment of the interior of the PS facing the on-screen display. In this embodiment, the on-screen display housing 1009 may include an on-screen display with touch screen capabilities. The housing 1009 may also include the following: a flash 1006, a bounce flash 1002, a soft panel light 1012, a ring flash 1018, a camera 1016, a security camera 1010, speakers 102, an input/output port for a cell phone or other personal device appliance 1040, a printer 1022, a printer tray 1024, a DVD/CD burner 1030 and/or a payment machine 1026. FIG. 10 also shows the open area 1028 between the top of the PS and the side walls of the PS in one embodiment.

The PS may generally require power to perform adequately and/or optimally. The PS may run on electrical power via, for instance, an electrical plug-in adapter, mechanical electricity generation, battery, DC, 110V, generator, or any other known method of providing electrical power. Further, as described above, in some embodiments, the PS may be provided with a solar power electricity generating unit 286 for powering one or more components of the PS. The solar unit 286 may provide the sole source of electrical power, or it may be provided with other electrical powering options as discussed.

Turning now to the interactive photography system (“IPS”) of the PS—the IPS may include a computer, software, a server, and/or connectivity capabilities, for example, in some embodiments.

The IPS may include several computers, in some embodiments, identical or distinct from one other. For example, in some embodiments, the camera 424 may have a computer, the display 470 may have a computer, and/or the printer may have a computer system. In another embodiment, the PS may have one computer comprising the IPS. In another embodiment, the IPS may include a server component that may add database and/or web interface capabilities.

The computer in some embodiments may include a processor, short term memory, long term memory, an input/output module, and/or a network connectivity device, for example.

In some embodiment's the processor may be a dedicated processor specially designed and configured for the IPS of the PS, but in other embodiments it may be a general purpose microprocessor such as made by Intel™, AMD™ or other suitable vendor such as may generally be found in home personal computer systems. The processor may execute the computer instructions residing in the software code.

In some embodiments, the short term memory may include Random Access Memory or other suitable memory, or combination of memory types for storing, loading, and executing program code, pictures and/or other data.

Long term memory in some embodiments may comprise a hard drive, a bootable CD-ROM drive, static memory, a network boot or any other form, or combination of forms of long-term storage that may be capable of, for example, supplying operating or application code to boot up and run the computer.

The input/output module may be any method for accepting user input from the user and displaying output to the user, for example. In some embodiments, the input and output devices may include, for example, but not limited to the interactive screen 480 and/or on-screen display 470. In some other embodiments, the input/output system may include, for example, the payment system 410. In some other embodiments, the input/output system may include a CD-R, CD-RW, writable DVD, or writable Blu-Ray™ system, for example. In some embodiments, the input/output system may include a way to control the camera 424, lighting system, and/or other features or aspects of the PPC. Such input/output may be through serial, COM, USB, ethernet, DVI, component video, RCA video, S-Video, HDMIT™, wireless connections, onboard connections such as PCI, PCI Express, AGP, ISA, or any other internal connection method, or combination of methods.

The IPS may also include a server in some embodiments. The server may be any computer system configured to store and retrieve photos and or videos and to interact with the internet, serving up web-pages and other customized content. The server may be connected to the internet, and may be connected to the PS through the internet, or any other connection method. In some embodiments, the server may be located in the PS itself, either as a separate computer system, or the same computer system as the IPS. The server in some embodiments may be remotely located. In another embodiment, the server may be located on site but not in the PS, while in still other embodiments the server may be located in the PS but separate from the IPS. The server may include a database or other large storage system for storing and retrieving photographs or videos, for example. The server may include a web-interface or web-server component to allow the server to securely present the customer's photos to the customer over the internet for additional purchases at a later time, in some embodiments. The server may also include a connectivity method for processing orders for custom products such as mugs, t-shirts, etc.

The server in some embodiments can include a processor, short term memory, long term memory, an input/output module, and a database or other large storage mechanism as described above in relation to the computer or computers that may be included in the IPS. In some embodiments, the server may be connected to the PS via on-site synchronous connectivity where available.

The server application level software module can include web server software, PPC interface software, a database interface software, and a maintenance and configuration module.

The web server in some embodiments may be any software module designed to securely allow customers to view their photos and/or videos at a later date and make purchases, view orders, prepay for photo-sessions or any other desirable function, for example.

In some embodiments, the PPC interface software may be any software module designed to communicate with the various PPCs that may be managed by the server. Such software may facilitate the uploading of customer photos from the PPC, change settings on the PPC, and/or monitor the PPC's functionality, for example.

The database software may be any software that can be used to manage the PPC's settings, store photos, and/or other long term storage tasks for example.

The maintenance and configuration module may be used to change settings on the server, in some embodiments. Such settings may include: which options are available on which PPC's; which PPC's are associated with a server; which options a customer can choose; pricing; terms of use; and/or other parameters.

In some embodiments, the network connectivity device may be an ethernet card, a wireless card such as WiFi, Bluetooth™, cellular, Infra-Red, modem, or a satellite card or any other suitable method, or combination of methods for linking the IPS to the internet, and/or other network system. In other embodiments, the network connectivity device may be designed to connect the IPC peer-to-peer with another computer or system, for example a monitoring system, or a database system, or the server system, or to the internet.

The software component of the PPC may include a Basic Input and Output System (BIOS) module, an Operating System (O/S) module, and/or an application level module.

In some embodiments, the BIOS may include any software specially designed to identify, test, and/or initialize hardware system devices. The BIOS may set the machine hardware into a known state, so that the software may be loaded, executed, and given control of the computer, for example. The BIOS may also be an Extensible Firmware Interface (EFI). The BIOS or EFI may be any commercially available product, or any specially designed firmware.

The Operating System (O/S) may be any software for controlling the hardware devices on the computer or computers and for facilitating the execution of the application level software and/or the network and input/output components. In some embodiments, for example, the Operating System module may be any commercially available O/S such as Microsoft Windows™, DOS™, UNIX™, LINUX™, or Apple OS™, or may be specially programmed software, or any other operating system.

The application level software module may be any way to control—through the Operating System—the interactive screen 480 and onscreen display 470, for example, in some embodiments, while in other embodiments the application level may control or may also control the camera 424, lens 430, and/or other camera equipment. The application level software may include, in some embodiments, a method for taking, reviewing, editing, and/or customizing photographs or other products, in addition to, in some embodiments, means for printing, saving, storing to a CD, DVD, or Blu-Ray™ disc, uploading to the internet and/or emailing the photographs to a user or a person identified by the user, for example. The software may control, or may also control lighting, focus, timing, and/or the presentation of pictures or other products. The application level software may control or be linked to the payment system in some embodiments so that pictures are taken and/or saved only if the customer has paid, for example. The software may also utilize digital photography editing features such as, but not limited to those commonly available in commercially available applications such as Photoshop™ by Adobe which may permit the user to edit their photos by, for example but not limited to, cropping, zooming, touching-up, and/or changing the color or tone of the photo, for example. Additionally, the application level software may include facial, and or expressional detection software for use in embodiments including an interactive guide.

The application level software, in some embodiments, may include one, two or more different platforms in order to provide a user with different levels and/or types of experiences. In some cases, a user may select which platform they wish to use, while in other embodiments, the platform may already be selected.

In some embodiments, one platform may direct the user through the media session by simple voice over instructions. In another embodiment, directions may be printed on the on-screen display that tell a user what to do next or what will happen next, for example. In other embodiments, a combination of vocal recordings, video elements, text elements, and/or user-response, for instance, a user choosing selections by touch-screen or keypad, may be used.

In some embodiments, one platform may include an interactive guide that may be displayed on the on-screen display and that may direct the user through the photo process. The guide may be female, male, old, young, middle-aged, and/or of any nationality, or alternately the guide may be a character, an animal, an avatar, or a cartoon character, for example. In some embodiments, a user may select the attributes of the guide, while in other embodiments the guide may already be selected for the user. The guide may communicate with the user with spoken words or in other cases in written words that may be displayed on the on-screen display 470 and/or on the interactive display 480. In this way, users that may be seeing or hearing impaired may be able to easily use the PS. The software may also provide guides that may speak in foreign languages and/or provide text on the on-screen display 470 and/or interactive screen 480 in foreign languages such that non-native English speakers may easily use the PS in their native language.

In some embodiments, the interactive guide feature may provide a photographic experience that may be substantially similar to an experience conducted by a live photographer that might prompt the user after each photo is taken. For example, the guide, model, or spokesperson may say something after each timed image is taken and then let the user know when the next photo will flash. A typical response from the model or spokesperson may be something like, “wow, you look great! Ok next photo, get ready, pose.” The flash may be set and the photo taken. The response of the model or spokesperson may be based on intelligent reactive software that can tell if the user is being serious, silly, fun, sexy, sad, etc. Expression telling software may be used so that the model or spokesperson can intelligently communicate with the user or can prompt the user to change poses so that there may be a variety of photos from which to choose. Commercially available examples of expression telling software that may be used with embodiments of the present disclosure, include for example, but are not limited to, Photostudio Expressions software by ArcSoft. PhotoNation also makes software that may be used in some embodiments to detect smiles and face tracking in portrait photography that may enable a picture to be taken when a smile is detected on the user, for example. Reallusion FaceFilter Studio software, or similar commercially available software, may also be used to remove unwanted facial expressions, blemishes, and wrinkles, for example. ArcSoft also makes software called PhotoStudio6 that allows a user to enhance, crop, and otherwise edit photos that may be used in some embodiments. 123 VideoMagic Pro, for example, makes software that may allow for different backgrounds via green screen/chroma-key software. Such software may replace a green background with another chosen image, for example, and may be used with some embodiments of the present disclosure. Any other suitable commercially available software may be used or may also be used in some embodiments.

Additional software may be provided that may display content on the on-screen display 470 that may be likely to elicit desired responses from a user. This software has been developed over years of researching what actions or activities, for example, might result in specific and desirable reactions in people. Such software may enhance the overall picture taking experience for the user via advanced human to computer interfaces enabling the user to interact with an on-screen photographer guide. In some embodiments, the software may be generally directed to anybody, while other embodiments of the software may have different versions available depending on the attributes of the user. For example, different modes may be available for babies, young children who do not yet speak, speaking children, adolescents, adults, men, women, different cultural groups, etc. This software may be particularly useful and advantageous for use with younger children. For example, a laughing or funny animal or situation may be shown on the screen to try to get the user to smile or laugh. Additionally, the guide or model may play peek-a-boo with the child, show puppets, sing, or any other activity that a child, for example in one embodiment, might respond to in a desirable way. Other modes, for example, directed to adults, may include a model or guide that tells jokes, does a funny dance, shows bloopers, or other types of content that may result in the user responding in a desirable way. Any other suitable content may be provided by the software and displayed on the screen to try to get the subject to react in a desired way. In some embodiments where a facilitator, such as a character, a parent, or a professional photographer may be assisting with the photo session, the facilitator may control the software such that the on-screen display may move more quickly through the scenes or activities, for example. In another embodiment the facilitator may be able to or may also be able to select which activity or scene to run, for example.

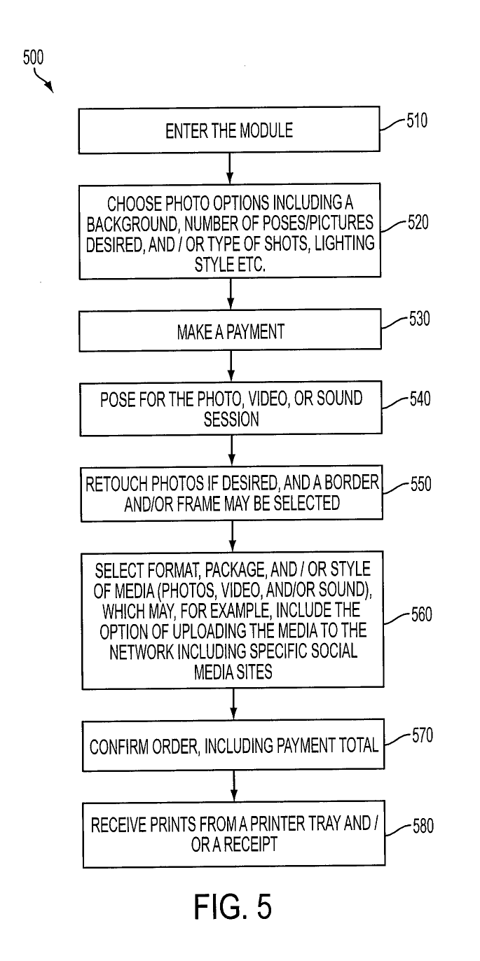

Following will be a general process 500 description of how the IPS of the PS may work as a user is guided through the photo session from start to finish, according to some embodiments of the present disclosure and as shown in FIG. 5. While specific contemplated uses will be discussed in greater detail further below, the following description may apply in whole, or in part, to one or more of the specific contemplated uses described below.

Upon a user entering the PS to begin a photo session 510, the on-screen display may display video software that in some embodiments may include an on-screen guide, model, or spokesperson. The software may be motion-activated such that when a person enters the module, the on-screen guide may begin talking and or text may display on the screen in response to the presence of the person or people. In other embodiments, the software may be activated by a user touching a “start” button for example on the touch-screen or elsewhere.

Once the software is activated, the on-screen model or spokesperson may prompt the user to choose photo options 520, for example, a background from the many choice images on the panel below the screen. The user may then directly touch the image on the screen that they want for a background. Background images may include copyright released photos of beautiful scenes such as national parks, landscapes, buildings including landmarks such as the Eiffel Tower, cars, licensed sports figures or Hollywood characters, or a pallette of colors for a more simple background. For example, high school seniors may choose the year they graduate as a background, couples may choose fireworks for an engagement announcement, a parent may choose their child's age, a business person may want a simple grey background for a professional head-shot for the newspaper, etc. The module may further allow for the user to upload their own custom background, for example, through a scanner that may be provided in or near the module, such that the user may have their own custom background in the user's pictures. After touching the background image that the user wants, the background may then be displayed on the on-screen display, in some embodiments.

The state of the art integrated software of the present disclosure may allow for a variety of shots or modes, including, but not limited to portrait (head and shoulders), three quarter, product (placed on the posing table, for example), group, movie recording, and 3D, in some embodiments. The subject may be captured in some embodiments with full HD high spectrum movie recording equipment, which may be SDHX compatible and provide live feedback on the on-screen display 470 and/or interactive screen 480 allowing the subject to see how they look before the shutter is released. A user may also record an HD movie along with voice in order to shoot a video or record a song, for example, in some embodiments.

The user may be prompted by the guide or model to consider what other photo options they would like, for example, what type of shot or mode they would like. For example, would they like a close-up, three quarters, product, or group shot, movie, etc. The user may simply touch the option on the screen corresponding to the type of shot, mode, and/or pose they want. At this point, in some embodiments, the on-screen display may show a live video image of the user so that the user may see in real-time what they will look like in a photo. The model or spokesperson may tell the user what to expect; for example, in one embodiment, the model or spokesperson may say something similar to, for example:
You will have four poses and during each pose the studio lighting will flash creating your amazing photo! We've created fantastic light to make sure you look your very best. Don't worry, I will tell you when each photo is going to be taken so that you can look different in each shot. Below are some sample poses, but go ahead and be creative. Remember, you're really the creator and star in your own photo shoot. We've just set it up for you.

The model or spokesperson may guide the user to make an initial cash or credit card payment 530 via, in some embodiments, the remotely monitored processing terminal on a dashboard next to the on-screen display to start their photo session. The credit card receiver or change receiver may be used to receive payment. It will be recognized that in other embodiments the user may be directed to provide payment at any other time during the process, including in some embodiments providing payments in advance from a remote location as discussed further below. In some embodiments, the user may also be asked to provide their name, email address, and/or mailing address via the interactive display 480 or other input device.

Once payment is made, the model or spokesperson may guide the user through the photo shoot 540 as described above in accordance with some embodiments of the present disclosure by prompting the user after each photo is taken. The photo shoot may take any appropriate length of time, in some cases each shot may take approximately 10 seconds.

The photography equipment may be actuated automatically, or it may be actuated, for example, by a timer, which may be activated by a user via the on-screen display 470 or the touch panel, or by a remote or wireless actuator, such that when activated by a user, the shutter is released and a photograph is taken. For example, the user may activate the shutter when the user sees a pose the user wishes to capture on the on-screen display 470. Each actuation of the photography equipment may result in one or more photographs being taken. In some embodiments, the remote, for example infrared or bluetooth, or wireless actuator may be incorporated into the bench 302, as was described above. In other embodiments, the actuator may be located at other locations within the module, or outside the module.

Once one or more photographs have been taken, the model or spokesperson may comment on the photographs. The user may be prompted, for example, to consider whether or not they would like retouching 550. Retouching software may be provided in a manner such that it is easy to use by the user. Retouching of, for example, but not limited to simple acne, scars, the areas under eyes, and lines may be fixed simply by touching directly on the spots on the photo displayed on the screen that the user wishes to correct. In addition to retouching, in some embodiments, a user may otherwise edit their photos or images. For example, in some embodiments, a user may be able to crop, change the rotation, view, lighting and/or coloring of their photos or images. The model or spokesperson may show the user how to do the retouching.

The user may be further guided as to whether the user would prefer the photographs in color, black and white, or sepia, for example 560. A particularly advantageous feature of many embodiments may be that the photographs may be immediately displayed on the on-screen display in color, black and white, sepia, and a variety of formats, packages, and styles. This may be advantageous over even traditional photo studios that may not be able to show the photographs in real-time during a photo shoot.

A variety of sample packages including copyright released DVDs and cards may also be displayed so that the user can actually see what the final images look like. The user may touch the packages or enlargements that the user would like. The user may then be asked if they would like glossy or matte and if they would like any text added to the card or photos, for example, such as a name or date. Package options, in some embodiments, may include, for example identification photos meeting ISO guidelines that may be used, for example, for passports, and other purposes that require a particular size and/or format for the photos, for example. After the user selects which packages they would like, the packages may be displayed and costs totaled. The user may be given the opportunity of removing any packages from the order and a new total may be provided 570.

The user may also be asked if they would like to order any of the products available on-line such as coffee mugs, jewelry, clothing, or bags. Samples may be shown with the user's image already applied. If the user wants to order these items they may do so and may type in the address that they would like the items sent to. The model or spokesperson may then ask if the user would like to use the same credit card for payment or provide the total amount of cash due for the order. Payment may be made via the credit card receiver or change receiver, for example. A receipt may then be printed 580.

While in some embodiments the final product or products may be provided directly to the user at the end of a photo session, some specialty final products, for instance, may be mailed to the user at a later time, or may be held for pick up at a desired or identified location. For example, if during the photo session the user purchases a coffee mug with a photo on it; such a product may be produced and mailed to the client at a later date. In order to accomplish this, in some embodiments the images to be used on the final product may be archived on the server that supports the PS, such that the processing of the special order may be completed remotely and/or at a later time. In one embodiment, a database management system may be incorporated into the integrated photography system for storing images. In other embodiments, all images taken during a photo session may be archived to a server, either located remotely or on-site. In still other embodiments, the images that the user does not select for purchase at the end of a photo session may be discarded, while only the images selected may be stored. A user may then be able to order additional products through the interne at a later date. The PS may give the customers a username/password or some other access code to direct them to their photos and/or videos located on the server in some embodiments.

The photographs selected for purchase may be provided by a printer and a print tray 494, which in some embodiments may be incorporated into the module. The printer may be configured to provide photographs in various commercially available sizes, including but not limited to 5×7 inch, 8×10 inch, etc. In other embodiments, the photographs may be provided in other media form, such as CD, DVD, Blue-Ray™, or other digitally accessible format. In further embodiments, a user may post the images directly on a network, such as the internet, so that, for example, the pictures may be available to others, such as friends and relatives, for viewing and purchasing.

The hardware-software encryption provided in the PS system in some embodiments may allow data transfer to a private network, the internet, websites, other social media outlets and more. In some embodiments, the PS may include a connection for instant printing and downloading of images from a camera phone that may be located, for example, at the base of the on-screen display, although such a connection might be placed in any suitable location.

As discussed briefly above, in some embodiments, a user may pay for services in advance from home, order additional photographs from home, or perform other suitable remote tasks related to the services provided by the module, for example, by means of a wireless adaptor incorporated into the PS.

The wireless adaptor may be used, or may also be used, in some embodiments to monitor use, payments, security, paper supply, or any other aspect of the operation of the module. One or more modules may thus be incorporated into a wider network and monitored simultaneously by one or more operators. Furthermore, the wireless adapter or other remote connection means may provide the ability to take photographs and upload the images directly to various websites, such as but not limited to e-Bay. For example, in commercial uses of the PS, a user may wish to sell a product by placing a picture of the product on a website. The PS may be used to take a high-quality photo or photos of the product for such a purpose. In some embodiments, the posing table 314 may be configurable to accommodate such commercial uses.

The PS of the present disclosure may be used in multiple modes. For example, the PS may be used in a self-activated mode as was generally described above. In still another use, the PS may be used by a photographer, in some cases a professional photographer, as a professional studio, or studio-on-the-go. The PS may also be used in conjunction with a character, such as Santa or the Easter Bunny, in some embodiments. While these uses are described further below, it will be recognized that still other uses of the PS are possible and remain within the spirit and scope of the present disclosure.

The PS may be used in a self-activated mode when the PS is located, for example in a mall or other business, whereby users may enter the module and use the module substantially unsupervised and/or unassisted. In some cases, the PS or PSs may be assigned a permanent location in the mall or business, and may be connected via an Ethernet line to the Internet. The PS may be operational continuously, or it may only be operational during mall operating hours, for example. In some embodiments, mall or business management may be responsible for replacing paper and other supplies that may be required. Additional products and services may be supported at these self-service locations; for example, video and sound features may be integrated with the photoshoot event such that streaming video, in addition to still frame photographs may be archived. Alternatively, DVDs might be made available on-site in addition to quality, printed photos.

In other cases, the PS may be rented, leased, or otherwise used by families, companies, or others to have at events, such as graduations, company parties, birthday parties or any other event. In such cases, users may also use the PS substantially independently. In still other uses, a photographer may rent, lease, or license, for example a PS to bring to events or other locations and supervise and/or oversee the photo sessions and the use of the PS.

In these uses, where the PS may be transported to a location for a limited time, for example, the system may require pre-programming before being activated by a signal or password sent from the system server, for example. In some embodiments, the signal or password may be downloaded once the “event” has been registered on-line by the photographer, for example.

Such registration may be completed on-site as the event gets underway, in some embodiments. If on-site connectivity to the web is unavailable, the user may connect the PS to the system server in advance of the event, register the event, and receive the password to activate the system, according to some embodiments.

In another contemplated use of the present disclosure, the PS may be used with a character, such as Santa or the Easter Bunny as an alternative to existing options for such photographic experiences. While this embodiment may be described with respect to Santa, it will be understood that any other character, person, etc. may be used in conjunction with the PS in this way. In use, the PS system may function substantially similarly to the self-activated mode and other modes described above, but with some differences in some embodiments, as explained below.

Upon entering the PS, and in some embodiments after making payment as described above, an image may be taken immediately. The on-screen display guide may talk with the child and/or parent to get their attention; for example, the model or spokesperson may do things to get the child or other users to smile, giggle, look forward toward the camera lens, etc. As stated above, the model or spokesperson may intelligently react to the response from the users.

In further embodiments, Santa may have the ability to choose which intelligent software to play based on the age of the user while live replay is on the on-screen display keeping the user's attention. This may be done remotely by Santa or the Character via a remote device built into the bench. The child/user may be able to see the video and play along with the model or spokesperson such as in a professional photo studio. The intelligent software may have the ability to get the intended reactions from years of research, providing delightful photos of the subject's reactions and personality. For example, the model or spokesperson may play peek-a-boo with the child/user or sing a song as prompted by Santa or the Character as they watch the child's/user's live reaction to model or spokesperson on the on-screen display. When Santa or the Character sees the reaction or best pose of the child while watching the child on the live play screen, he may then take the photo by releasing the shutter on the high-quality photography equipment via remote. This live play of the user and the ability of the character to remotely actuate the shutter in real time based on what the character is seeing on the live play screen may greatly enhance the ability of the user or character to capture the perfect pose.

The photos may then be displayed on the panel as they are taken over the course of a minute or two. The intelligent software may be monitored by Santa or the Character, giving him the opportunity to visit with the subject once the photos are taken. Meanwhile the parent, guardian or the child/user may view the poses on the display panel and may be instructed what to do next by the model or spokesperson. The parent, guardian or child/user may touch which image or images they would like. The remainder of the process may proceed substantially as described above with respect to other embodiments.

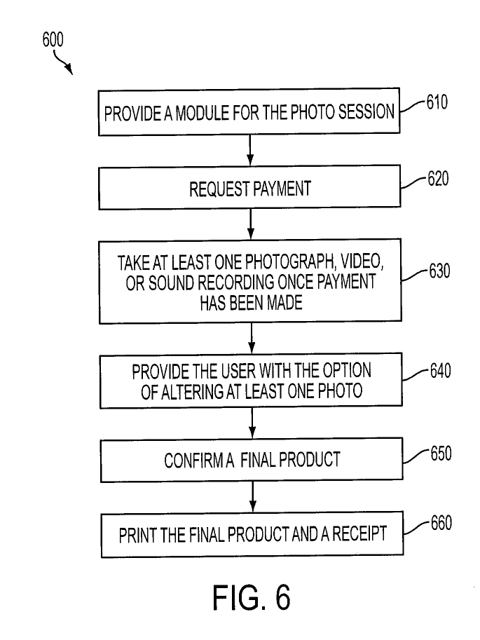

A method for using 600 the PS according to some embodiments of the present disclosure is described and shown in FIG. 6. At step 610, a module may be provided for conducting a photo session from start to finish. By means of an integrated photography system (IPS) of the PS, a user may be guided through the photo session. At step 620, the user may be asked to pay for a photo, video, and/or sound session they may have selected for purchase. The IPS of the PS may then direct the user through a photo session, video session, and/or sound session at step 630. At step 640, the user may be given the option of retouching or otherwise altering the photos, videos, and/or sounds that have been captured by the IPS of the PS. The user may then be asked to confirm their order at step 650. Final products that have been confirmed and that are available on-site may be printed along with a receipt and instructions for how to obtain any products purchased that will be produced at a later time and sent to the user at step 660.

Although the present disclosure has been described with reference to certain embodiments, persons skilled in the art will recognize that changes may be made in form and detail without departing from the spirit and scope of the invention.

What is claimed is:

1. A portable studio comprising:
a module with an interior and an exterior, comprising:
a floor comprised of at least one panel;
side walls detachably connectable to the floor, wherein the side walls are comprised of at least one panel;
a top detachably connectable to the side walls, wherein the top is comprised of at least one panel;
wherein the side walls and the top are comprised of a semi-translucent material that allows ambient light into the interior of the module, and wherein the module is configured to create studio quality photos, videos, and sound recordings.

2. The apparatus of claim 1, further comprising software for directing a user through a photo session.

3. The apparatus of claim 2, wherein the software comprises providing a model or spokesperson on an on-screen display to guide the user through a photo session, the model or spokesperson being capable of recognizing and responding to the user based on the user's facial expressions.

4. The apparatus of claim 1, further comprising high-quality photography equipment capable of creating photographs, video, and sound recordings.

5. The apparatus of claim 1, further comprising wheels for moving the module.

6. The apparatus of claim 5, wherein the wheels are retractable into the module.

7. The apparatus of claim 1, the module further comprising a division area that allows the module to be expanded to accommodate four or more people.

8. A portable studio, comprising:
a module having a generally curved exterior, a semi-translucent top, and an inside of sufficient size to allow entry to the inside by at least one person;
high-quality photography equipment;
an on-screen display;
a printer operably connected to the high-quality photography equipment;
payment mechanism located on the module;
a server operably connecting the photography equipment, the on-screen display, the printer and the payment mechanism; and
software that displays an interactive guide on the on-screen display that guides the at least one person in the use of the apparatus.

9. The system of claim 8, further comprising a wireless adapter capable of connecting remotely to a network.

10. The system of claim 8, further comprising high-quality digital movie making equipment.

11. The system of claim 8, further comprising a means for receiving and recording sound on the inside of the module.

12. The system of claim 8, further comprising wheels provided on the module.

13. The system of claim 8, wherein the model or spokesperson is an interactive guide provided by means of the software and is capable of recognizing and responding to a user based on the user's facial expressions.

14. The system of claim 8, the module further comprising a division area that allows the module to be expanded to accommodate four or more people.

15. A method for providing an interactive photo session, comprising:
providing a module having a generally curved exterior, a semi-translucent top, and an inside of sufficient size to allow entry to the inside by at least one person in order for a photo session to be initiated and completed, the module comprising;
high-quality photography equipment;
an on-screen display;
a printer;
payment mechanism;
a server operably connecting the photography equipment, the on-screen display, the printer and the payment means; and
software that displays an interactive guide on the on-screen display that guides the at least one person in the use of the apparatus;
directing the at least one person once they have entered the module to select photo options for their photo session;
requesting payment from the at least one person via the payment means;
capturing at least one photograph, video image, or sound recording of the at least one person;
providing the at least one person the option of altering the photograph, video image, or sound recording;
confirming a final product the at least one person will purchase; and
making the final product available to the at least one person.

16. The method of claim 15, wherein the photo options include at least one of the number of pictures they want taken, the type of shot they want for each picture, and the background they want for each picture.

17. The method of claim 15, wherein the user may select a digital video as a photo option.

18. The method of claim 15, wherein the model or spokesperson is an interactive guide provided by means of the software and is capable of recognizing and responding to a user based on the user's facial expressions.

19. The method of claim 15, the module further comprising a division area that allows the module to be expanded to accommodate four or more people.

20. The method of claim 15, further comprising a character provided to pose with the at least one user.
